(19) United States
(12) Patent Application Publication
(10) Pub. No.: US 2014/0039972 A1
(43) Pub. Date: Feb. 6, 2014

(54) AUTOMATIC DETECTION OF DIFFERENT TYPES OF CHANGES IN A BUSINESS PROCESS

(71) Applicant: INTERNATIONAL BUSINESS MACHINES CORPORATION, Armonk, NY (US)

(72) Inventors: SONGYUN DUAN, HASTINGS-ON-HUDSON, NY (US); PAUL T. KEYSER, CHICAGO, IL (US); GEETIKA T. LAKSHMANAN, WINCHESTER, MA (US); DAVOOD SHAMSI, PALO ALTO, CA (US)

(73) Assignee: INTERNATIONAL BUSINESS MACHINES CORPORATION, ARMONK, NY (US)

(21) Appl. No.: 14/054,468

(22) Filed: Oct. 15, 2013

Related U.S. Application Data
(62) Division of application No. 13/081,299, filed on Apr. 6, 2011.

(51) Int. Cl. G06Q 10/06

(52) U.S. Cl. CPC G06Q 10/0633
USPC 705/7.27

(57) ABSTRACT

Systems and methods are provided for the automatic detection of different types of changes in a business process. A system includes a transformer for performing a transformation on data derived from process traces or models extracted from the processes traces to generate transformed data. The process traces are for a business process corresponding to a set of related tasks for a specified goal. Each of the models has at least a transition matrix of dimension N×N, where N is a total number of the related tasks. The system further includes a change detector for performing change detection on the transformed data to identify at least one of when a change occurs in the business process and a degree of the change.

### RELATED APPLICATION INFORMATION

This application is a Divisional application of co-pending U.S. patent application Ser. No. 13/081,299 filed on Apr. 6, 2011, incorporated herein by reference in its entirety.

### BACKGROUND

1. Technical Field

The present invention generally relates to business processes and, more particularly, to the automatic detection of different types of changes in a business process.

2. Description of the Related Art

Semi-structured processes are emerging at a rapid pace in industries such as government, insurance, banking and healthcare. These business or scientific processes depart from the traditional kind of structured and sequential predefined processes. Their lifecycle is not fully driven by a formal process model. While an informal description of the process may be available in the form of a process graph, flow chart or an abstract state diagram, the execution of a semi-structured process is not completely controlled by a central entity (such as a workflow engine). Case oriented processes are an example of semi-structured business processes. Newly emerging markets as well as increased access to electronic case files have helped to drive market interest in commercially available content management solutions to manage case oriented processes.

Usually case handling systems present all data about a case at any time to a user who has relevant access privileges to that data. Furthermore, case management workflows are nondeterministic, characterized by one or more points where different continuations are possible. They are driven more by human decision making and content status than by other factors. These workflows may change frequently, depending on factors such as economic conditions, seasonal trends, legislative policy changes and technological upgrades. Consider for example how patient cases are handled at a hospital. A health care worker processes some data about the patient (such as health insurance, medical history, and today's food intake), and based on incoming data specific to each patient makes decisions on which task to do next.

Given their non-deterministic nature, and frequency of change, it would be particularly useful to determine when such a semi-structured business process changes and the degree of change in the process.

### SUMMARY

According to an aspect of the present principles, a system is provided. The system includes a transformer for performing a transformation on data derived from process traces or models extracted from the processes traces to generate transformed data. The process traces are for a business process corresponding to a set of related tasks for a specified goal. Each of the models has at least a transition matrix of dimension N×N, where N is a total number of the related tasks. The system further includes a change detector for performing change detection on the transformed data to identify at least one of when a change occurs in the business process and a degree of the change.

According to another aspect of the present principles, a method is provided. The method includes performing a transformation on data derived from process traces or models extracted from the processes traces to generate transformed data. The process traces are for a business process corresponding to a set of related tasks for a specified goal. Each of the models has at least a transition matrix of dimension N×N, where N is a total number of the related tasks. The method additionally includes storing the transformed data in a memory. The method further includes performing change detection on the transformed data to identify at least one of when a change occurs in the business process and a degree of the change.

According to still another aspect of the present principles, a system is provided. The system includes a transformer for receiving a plurality of process graphs for a business process corresponding to a set of related tasks for a specified goal and transforming each of the plurality of process graphs into a respective one of a plurality of matrices. Each of the plurality of matrices includes a plurality of real-values representing transition probabilities between different ones of the related tasks. The system further includes a change detector for performing at least one change detection process on respective spectrums of the plurality of process graphs, as represented by Eigenvalues of the plurality of matrices, to detect at least one of when a change occurs in the business process and a degree of the change.

According to a further aspect of the present principles, there is provided a method. The method includes receiving a plurality of process graphs for a business process corresponding to a set of related tasks for a specified goal. The method further includes transforming each of the plurality of process graphs into a respective one of a plurality of matrices. Each of the plurality of matrices includes a plurality of real-values representing transition probabilities between different ones of the related tasks. The method additionally includes storing the plurality of matrices in a memory. The method also includes performing at least one change detection process on respective spectrums of the plurality of process graphs, as represented by Eigenvalues of the plurality of matrices, to detect at least one of when a change occurs in the business process and a degree of the change.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system 100 to which the present invention may be applied, according to an embodiment of the present invention;

FIG. 2 is a block diagram showing an exemplary system 200 for change detection in a business process, according to an embodiment of the present principles;

FIG. 3 is a flow diagram showing an exemplary method 300 for change detection in a business process, according to an embodiment of the present principles;

FIG. 4 is a flow diagram showing an exemplary method 400 for change detection in a business process using domain transformation, according to an embodiment of the present principles;

FIG. 5 shows an exemplary plot 500 of magnitude versus frequency for a time-series of sound data, whose transform shows peaks at certain frequencies, according to an embodiment of the present principles;

FIG. 6 is a flow diagram showing an exemplary method 600 for change detection in a business process using the intersection of confidence intervals, according to an embodiment of the present principles;

FIG. 7 is a flow diagram showing an exemplary method 700 for change detection in a business process using multi-dimensional statistical change detection, according to an embodiment of the present principles;

FIG. 8 is a flow diagram showing an exemplary method 800 for change detection in a business process using spectral graph analysis, according to an embodiment of the present principles; and

FIG. 9 is a flow diagram showing an exemplary method 900 for change detection in a business process by deriving graphs from process traces and using spectral graph analysis, according to an embodiment of the present principles.

### DETAILED DESCRIPTION OF PREFERRED EMBODIMENTS

As noted above, the present principles are directed to the automatic detection of different types of changes in a business process. Advantageously, the present principles address the problem in that as processes change over time, we would like to be able to compare them in some unambiguous way, e.g., to be able to compute a distance measure between process P₀ and Pᵢ (with iε{1..}). It would not suffice merely to detect that Pᵢ is not isomorphic to P₀, as all that would mean is that Pᵢ has changed in some way to some degree. Rather, in one or more embodiments, we would like to have some numerical measure.

Thus present principles are applicable to processes that undergo and/or otherwise exhibit a periodic or a semi-periodic change, i.e., in which the process “oscillates” between two or more distinct states. For example, every business week a process might vary, or at the end of every quarter, or in some other way related to the purpose for which the process is being executed. Moreover, the present principles are applicable to processes that undergo and/otherwise exhibit a non-periodic change.

From a computational perspective, a business process can be seen as a collection of related tasks that lead to a specified goal. A process model S=(N,E,..) can be defined as a Well Structured Activity Net, where N constitutes the set of process activities and E is the set of control edges (i.e. precedence relations) linking them. The distance or similarity between two process models could be defined in a number of ways including the following: text similarity; structural similarity; and behavioral similarity. Text similarity is based on comparisons of labels that appear in the process models (task labels, event labels, etc), using syntactic or semantic similarity metrics. Structural similarity is based on the topology of the process models seen as graphs, possibly taking into account text similarity as well. Behavioral similarity is based on the execution semantics of process models.

Advantageously, the present principles are directed to detecting changes in an instance of a business process during runtime, and specifically seeking to determine when the change occurs (which set of traces) and the magnitude of the change. We do not make the assumptions made by known techniques that require the presence of change logs and/or first convert traces into a process model for the purposes of comparison. This flexibility makes the present principles particularly applicable to detecting changes in semi-structured business processes where execution is not necessarily driven by a formal process model, and thus mining a formal process model first in order to compute process changes may not make sense. In particular, the present principles can be used to determine when and the degree to which a mined adaptive representation of a semi-structured business process (e.g., a probabilistic graph) should be updated.

Various methods will be described herein. These methods include a frequency domain based method, an intersection of confidence intervals method, a multi-dimensional statistical change detection method, and a spectral graph analysis method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

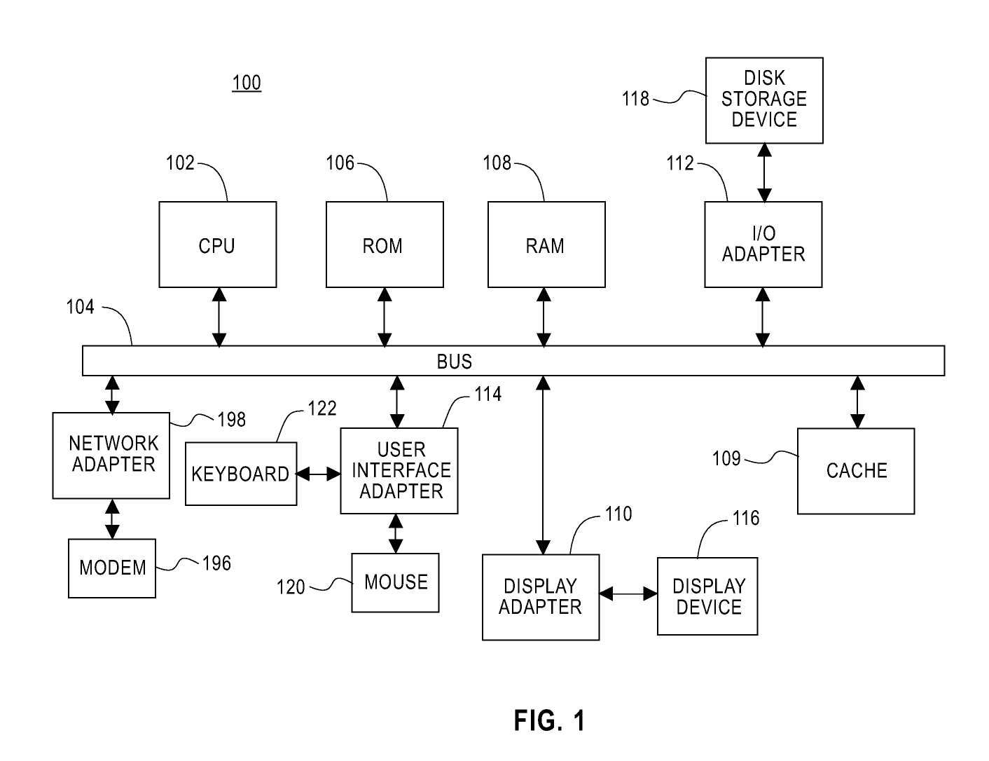

FIG. 1 is a block diagram showing an exemplary processing system 100 to which the present invention may be applied, according to an embodiment of the present invention. The processing system 100 includes at least one processor (CPU) 102 operatively coupled to other components via a system bus 104. A read only memory (ROM) 106, a random access memory (RAM) 108, a display adapter 110, an I/O adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A (digital and/or analog) modem 196 is operatively coupled to system bus 104 by network adapter 198.

Of course, the processing system 100 may also include other elements (not shown), including, but not limited to, a sound adapter and corresponding speaker(s), and so forth, as readily contemplated by one of skill in the art.

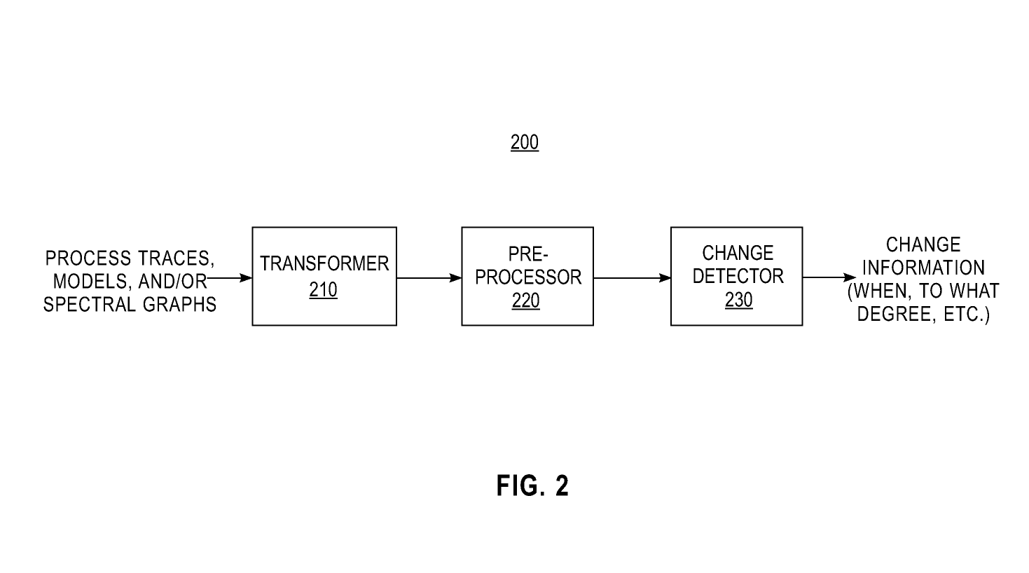

FIG. 2 is a block diagram showing an exemplary system 200 for change detection in a business process, according to an embodiment of the present principles. The system 200 includes a transformer 210, a pre-processor 220, and a change detector 230.

The transformer 210 receives data derived from process traces or from models extracted from the process traces or from graphs (such as, e.g. spectral graphs) to generate transformed data. The process traces and graphs are for a business process corresponding to a set of related tasks (also interchangeably referred to herein as activities) for a specified goal. Each of the models has at least a transition matrix of dimension N×N, where N is a total number of the related tasks. The transformer 210 performs a transformation on the derived data to generate transformed data.

The pre-processor 220 performs pre-processing on at least a portion of the transformed data in preparation for change detection. For example, in an embodiment, the pre-processor can include a smoothing filter for smoothing transformed values prior to change detection. Of course, the present principles are not limited to solely the preceding pre-processing function (i.e., smoothing) and, thus, other pre-processing functions may be performed on the transformed data prior to change detection, while maintaining the spirit of the present principles.

The change detector 230 performs change detection on the transformed data to output change information related to the business process (e.g., when a change occurs in the business process, a degree of the change, and so forth). For example, in an embodiment, the change detector 230 can include a peak detector for performing peak detection on transformed values to identify a degree of change in the business process, with other information such as, for example, corresponding frequency information, indicating a frequency at which the business process changes.

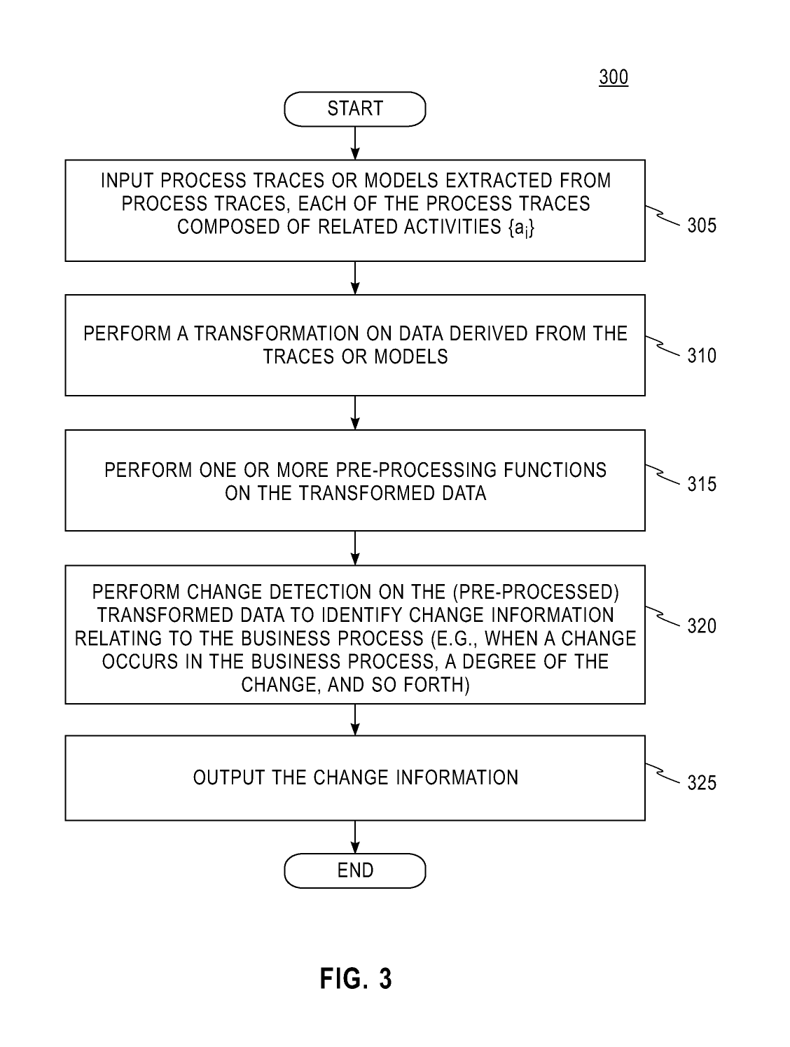

The system 200 may be used to perform any of the methods 300, 400, 600, 700, 800, and 900 described herein regarding FIGS. 3, 4, 6, 7, 8, and 9, respectively.

FIG. 3 is a flow diagram showing an exemplary method 300 for change detection in a business process, according to an embodiment of the present principles. At step 305, process traces or models extracted from the processes traces are input. The process traces are for a business process corresponding to a set of related tasks for a specified goal. Each of the models has at least a transition matrix of dimension N×N, where N is the total number of the related tasks. At step 310, a transformation is performed on data derived from the process traces or models to obtain transformed data. At step 315, one or more pre-processing functions are performed on the transformed data. At step 320, change detection is performed on the (pre-processed) transformed data to determine change information relating to the business process (e.g., when a change occurs in the business process, a degree of the change, and so forth). At step 325, the change information is output.

Input Data

In most cases, we may choose to use as the input data either: (a) the actual traces of the process or case (i.e., the logged sequence of events (tasks, and so forth) of the running process, where one trace represents one process-instance); or (b) a model extracted from those traces, which includes, at a minimum, a transition-matrix of dimension (N×N), where N is the total number of distinct tasks. However, in other cases, graphs may be used. The graphs may be derived, for example, from traces corresponding to the business process. The graphs may be, but are not limited to, spectral graphs, indicative of a spectrum of the business process or a subset thereof.

Periodically Changing Processes: The Frequency-Domain Method:

We note that the frequency domain method is also referred to herein as the Fourier transform method. We now describe an exemplary problem to which the frequency-domain method may be applied. Of course, the present principles are not limited to solely the following problem and, thus, may be applied to other problems as readily contemplated and encountered by one of skill in the art, while maintaining the spirit of the present principles. We imagine a set of activities, wherein each of the activities either occurs or does not occur in a given process-instance. For each activity, we somehow define a time-series, i.e., a list of pairs (time, value), and then want to ask “is the value changing slowly or rapidly, or both?” For example, if the value were temperature, and the activity was something like “measure the temperature”, and it occurred every hour, we would see a time-series that changed rapidly (over the course of a day), and slowly (over the course of a year). Now instead of temperature, we have things that vary in ways we cannot predict, but we would like to be able to find out how they vary over time. In particular, we would like to be able to distinguish between “rapid” changes (like temperature changes that occur over a day) and “slow” changes (like temperature changes that occur over a year).

Of course, in any given process-instance, it may be the case either that (a) there are only small changes (or even perhaps none at all), or else (b) that there are significant changes but at “all” frequencies, so that there is no unambiguous way to separate some changes as “rapid” and others as “slow”. Thus, the frequency-domain method only applies to those processes/models/graphs that are changing over time in at least semi-periodic ways.

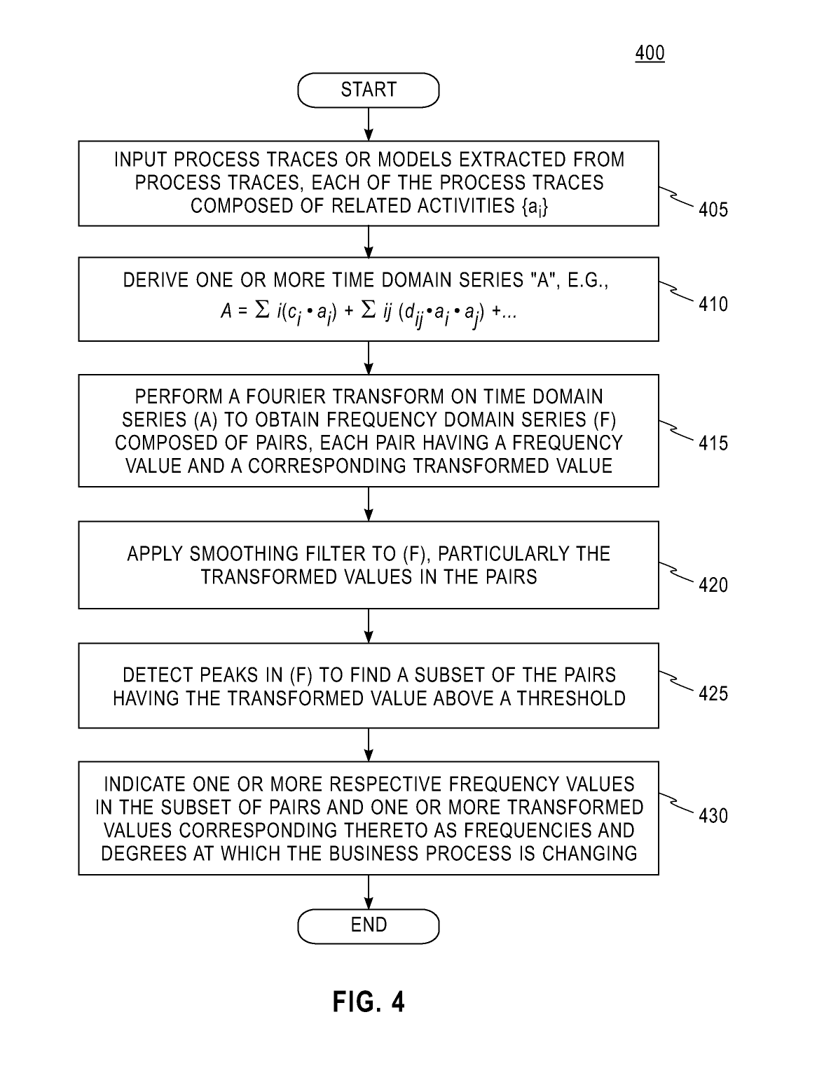

FIG. 4 is a flow diagram showing an exemplary method 400 for change detection in a business process using domain transformation, according to an embodiment of the present principles. In the method 400, time domain data is transformed to frequency domain data, and change detection is performed on the frequency domain data.

At step 405, process traces or models extracted from the processes traces are input. The process traces are for a business process corresponding to a set of related tasks {aᵢ} for a specified goal. Each of the models has at least a transition matrix of dimension N×N, where N is the total number of the related tasks.

At step 410, time domain series data is derived from the process traces or the models. For example, step 410 may involve deriving one or more time domain series “A”, for example, as follows: A=Σi(cᵢ·aᵢ)+Σij(dᵢⱼ·aᵢ·aⱼ)+ . . . .

At step 415, a Fourier transform is performed on the time-series data to obtain a frequency domain series composed of a set of pairs. Each of the pairs includes a frequency value and a transformed value corresponding thereto.

At step 420, the transformed values in each of the pairs are smoothed using a smoothing filter. It is to be appreciated that step 420 is optional.

At step 425, peak detection is performed on the set of pairs to find a subset of pairs having the transformed value above a threshold value.

At step 430, one or more respective frequency values in the subset of pairs and one or more transformed values corresponding thereto are respectively indicated as frequencies and degrees at which the business process is changing.

Referring back to FIG. 2 as it relates to method 300, we note that the transformer 210 can be a Fourier transformer, the pre-processor 220 can be and/or otherwise involve a smoothing filter, and the change detector 230 can be a peak detector.

Thus, we propose performing a Fourier Transform of the time-series data, which will result in a list of pairs (frequency, transformed value), and then searching for peaks in that graph (list of pairs). It is to be appreciated that the units of the transformed value may be, for example, “time*units of the input value”, but are rarely considered.

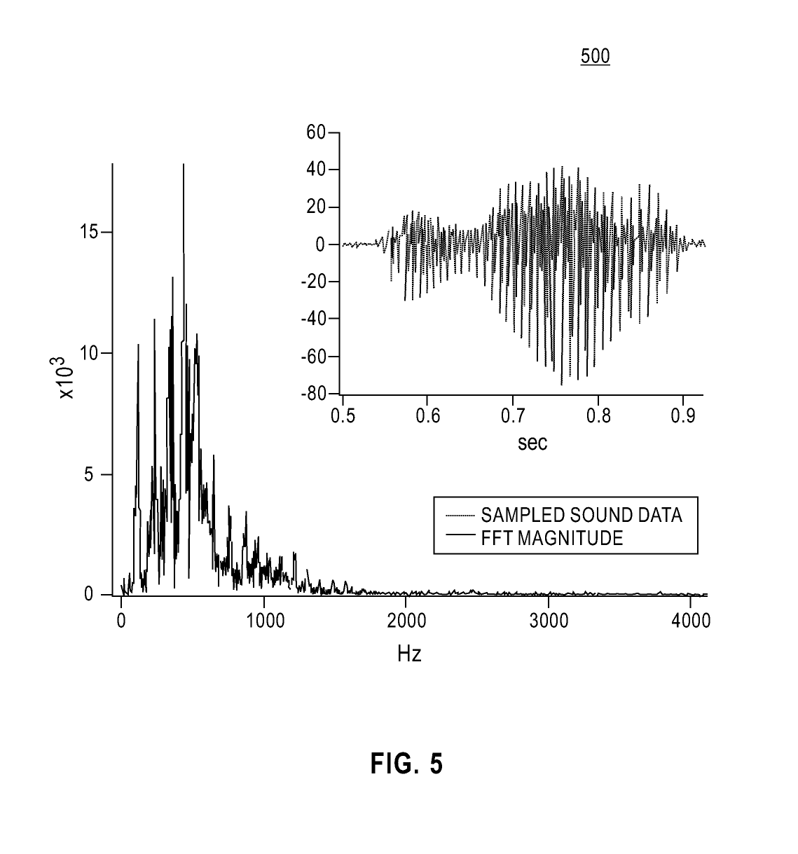

FIG. 5 shows an exemplary plot 500 of magnitude versus frequency for a time-series of sound data, whose transform shows peaks at certain frequencies, according to an embodiment of the present principles.

Note that the data that is input to the Fourier Transform is data about the activities (aka tasks aka todos) of the process, and could be (1) simply the list of {0, 1} values indicating whether the given activity executed in the K^{th} trace, or else (2) the list of {0, 1} values indicating whether the given transition was observed in the K^{th} trace, or else (3) the process-model as described above, with N×N values.

Before applying the Fourier Transform, we could combine A>1 activities as follows:

A(f)=Σᵢ(cᵢ·aᵢ)

where cᵢ might be, e.g., 2ⁱ, in which case we would have a kind of binary encoding, or cᵢ might be 1 for all i, etc. We might also think of some non-linear combination, which could get pretty complex and arbitrary, as follows:

A(f)=Σᵢⱼ(dᵢⱼ·aᵢ·aⱼ)+Σᵢⱼₖ(eᵢⱼₖ·aᵢ·aⱼ·aₖ)+ . . .

After the transform, and before finding peaks, it seems likely we will need to apply some smoothing filter to the data. Preferably, a Savitzky-Golay smoothing filter is used, as it tends to preserve features of the distribution such as relative maxima, minima and width, which are usually “flattened” by other adjacent averaging techniques. However, it is to be appreciated that the present principles are not limited to the preceding smoothing filter and, thus, other smoothing filters may also be used in accordance with the teachings of the present principles, while maintaining the spirit of the present principles.

Note that at this point in the process, we have enough data in hand to be able to say whether or not there are time-dependent patterns of change in the data (traces, models, and so forth). However, if we wish to characterize the period(s) at which change is occurring, for example “weekly” or “daily”, we would perform also the following step, namely peak detection.

There are a wide variety of peak-detection algorithms available (the problem is not simple), often involving baseline corrections and smoothing methods. One common approach is to apply smoothing followed by zero-crossing detection in the derivative, which tends to produce excess false peaks. It has been shown that the peak detection procedure is composed of the following three parts: smoothing, baseline correction and peak finding.

One method of peak detection is wavelet transforms. This can be made more sensitive and complex by applying various filters.

We propose a different and simpler way. We note that very often a Fourier transform has a baseline that looks like 1/fⁿ, where n is an exponent having a value greater than 0 (e.g., 2, 1, and so forth), and the peaks representing change may be modeled as Gaussians. It is to be appreciated that n may be an integer or a non-integer. Thus, to find the two highest peaks we can fit the Fourier-transform output to a function of f, with five parameters, {a, p₁, p₂, f₁, f₂} as follows:

(a/f²)+p₁·exp(−(f−f₁)²)+p₂·exp(−(f−f₂)²)

For the baseline term, instead of (a/f²), if there is a low-frequency “roll-off”, as in the sound spectrum above, we might add a sixth parameter ‘b’, and use something inspired by the well-known Maxwell-Boltzmann distribution such as, for example, the following:

a·(f/b³)^{1/2}·exp(−f/b)

Having detected the peak(s) of the Fourier-transform, we can then conclude that the process is changing at that/those frequencies. Furthermore we can ask if the frequency-spectrum changes over time. For example, a process observed to have a certain frequency-spectrum for executions occurring in the first six months of 2009, might have a different frequency-spectrum for executions occurring in the first six months of 2010.

Non-Periodic Processes: The Intersection of Confidence Intervals (ICI) Method

Many processes will change in non-periodic ways, or at least primarily in such ways. For processes varying in those ways, we propose the following suite of methods:

The basic idea is that we would compute the variance of the time-series as defined above, for some particular interval of time, and then repeat that calculation in successive intervals, as if in the ordinary moving average. That generates a sequence of confidence intervals taken at successive times.

Then change is detected when the confidence intervals no longer intersect. One way to perform such change detection is to use the “ICI” method as described herein.

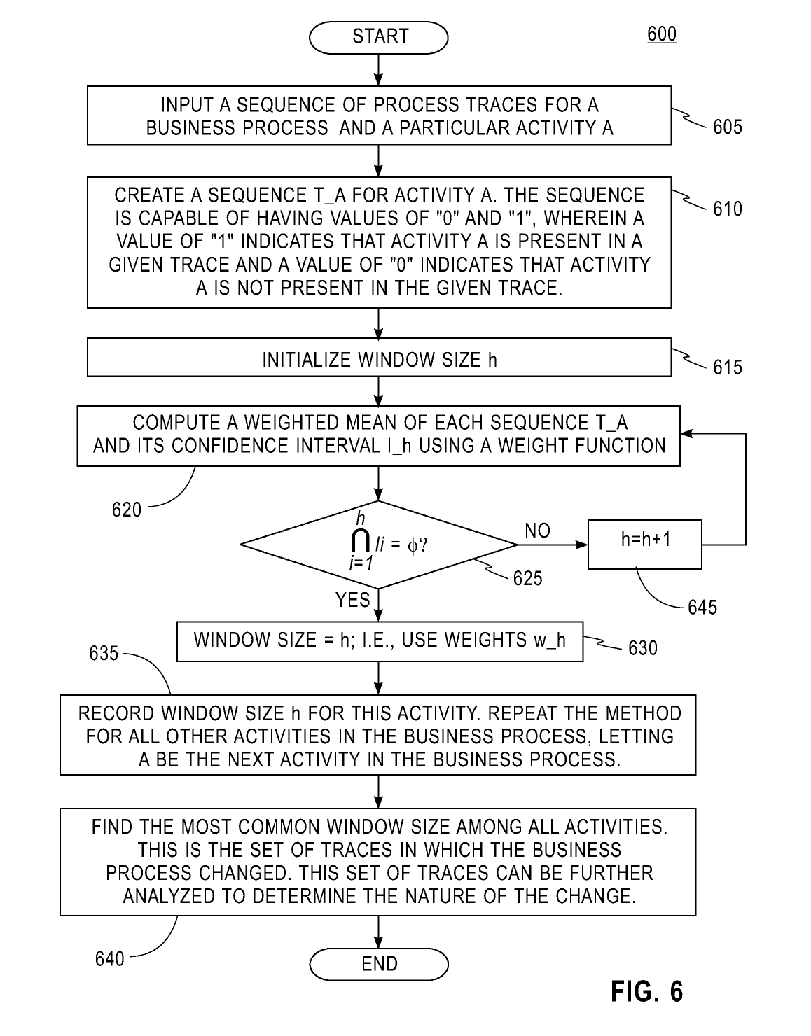

FIG. 6 is a flow diagram showing an exemplary method 600 for change detection in a business process using the intersection of confidence intervals, according to an embodiment of the present principles.

At step 605, a set of traces for a business process and a particular activity A in the business process (and hence the traces) are input.

At step 610, a sequence T_A is created for activity A in the traces, the sequence capable of having values of “0” and “1”, wherein a value of “1” indicates that activity A is present in a given trace and a value of “0” indicates that activity A is not present in the given trace. The length of the sequence is the number of traces.

At step 615, a variable h is initialized (e.g., set to a value of “1”), where h is a size of a window applied to the traces. In other words h represents a subset of a trace with |h| activities. h could have a value between 1 and the number of activities in a trace.

At step 620, a weighted mean (or any weighted property, as readily determined by one of skill in the art) of each sequence T_A and its confidence interval I_h is computed using a weight function w_h, where w_h(i)=w(i/h), and where w is a decreasing function.

At step 625, with regard to the intersection of confidence intervals (i, i+1, i+2, . . . , |h|) where |h| denotes the cardinality of the window size, it is determined whether or not ∩ᵢ₌₁^{h}Ii=φ, where φ denotes a null set or a set with zero cardinality. The₁ confidence interval for the same activity A is repeatedly computed while incrementally increasing the window size, until the intersection of any combination of confidence intervals in the set of intervals (i, i+1, i+2, . . . , |h|), where |h| denotes the cardinality of the window size, is the empty set. This is denoted by the notation: ∩ᵢ₌₁^{h}Ii=φ. If so, then the method proceeds to a step 630. Otherwise, the method proceeds to a step 645.

At step 630, the window size is set to h, i.e., use weights w_h. Note: for h=1, 2, . . . , w_h is a weight function. w_h(i)=w(i/h) where w is a decreasing function and i is the ith confidence interval.

At step 635, the window size h is recorded for activity A, and the method 600 is repeated for other activities in the business process/traces, letting A be the next activity to be processed in the business process/traces.

At step 640, the most common window size among all activities is found. The subset of the traces having the activity for which the most common window size is found is determined as having changed. Accordingly, further analysis of this subset of traces can be performed to determine the nature of the change.

At step 645, h is incremented by 1 (i.e., h=h+1), and the method returns to step 620.

Consider a process model M and executions L={l₁, l₂, l₃, . . . }. Each execution, such as l₁, is a sequence of tasks in the process model. For example, l₁ can be a sequence like “SABDRSFDE”, where each letter represents a task. For the moment, we focus on a particular task, for example task A. We can construct a sequence that represents membership of task A in the execution logs. Since A is observed in execution l₁, we put 1 in the first element of the sequence. If A does not belong to the execution lᵢ, then we put 0 in the i-th position. Then, for task A, we have a sequence such as, for example, T_{A}=1010110011 . . . . The goal is to detect any change in stochastic behavior of the time series T_{A}. Basically, here we look at the expected value of the time series.

To find average of the T_{A}, we can write the following:

$$E \{ {T}_{A} \} = \frac{{\sum }_{i = 1}^{n} {T}_{A} ( i )}{n}$$

where n=|T_{A}|. However, if T_{A} is a varying process, then we should only use recent values of the sequence to estimate the expected value. We can use a weighting function (window time) to estimate average as follows:

$${E}_{h} \{ {T}_{A} \} \approx {Q}_{h} = \frac{{\sum }_{i = 1}^{n} {w}_{h} {T}_{A} ( i )}{{\sum }_{i = 1}^{n} {w}_{h} ( i )}$$

Here wₕ(·) is a weight function and it is defined as follows:

wₕ(x)=w(x/h),

wherein w(·) is a fixed function and it is called base windows form function (BWFF). The main challenge is to find appropriate window size h.

Intersection of Confidence Intervals is a well known method for finding window size h. Assume we can approximate the variance of T_{A}(i). Then, we have the following:

$${σ}_{h}^{2} = var ( {Q}_{h} ) = \frac{{\sum }_{i = 1}^{n} {w}_{h} ( i ) var ( {T}_{A} ( i ) )}{{( {\sum }_{i = 1}^{n} {w}_{h} ( i ) )}^{2}}$$

Then, confidence interval of the Qₕ will be as follows:

Iₕ=(Qₕ−3σₕ,Qₕ+3σₕ)

Now, assume the window size “h” belongs to a countable ordered set H. For example, H={1, 2, 3, 4, 5, . . . }. Then, the window size “h” based on the ICI method is defined as follows:

h*=argmax_{hEH}{h:∩ᵢ₌₀^{h}Iᵢ≠φ}

It is to be appreciated that we can consider different time series in the logs. For example, if task A has 3 possible outputs, namely output 1, output 2, and output 3 (with an XOR relation), then one can construct a sequence like F=“12123212311”. Each number indicates which path after A is followed. For example, 1, 2, 3 are all possible paths that can be taken after A. Then, we might analysis the temporal behavior of the new sequence F.

The Multi-dimensional Statistical Change Detection Method

Denote A as the set of activities in the system. A trace is an ordered sequence of activities T=<a_1, a_2, . . . , a_n>, where a_i belongs to A. To detect changes in the process model that generates observed traces, we represent each trace as a point in a multi-dimensional space, which will be described below, and apply change detection techniques in the multi-dimensional space.

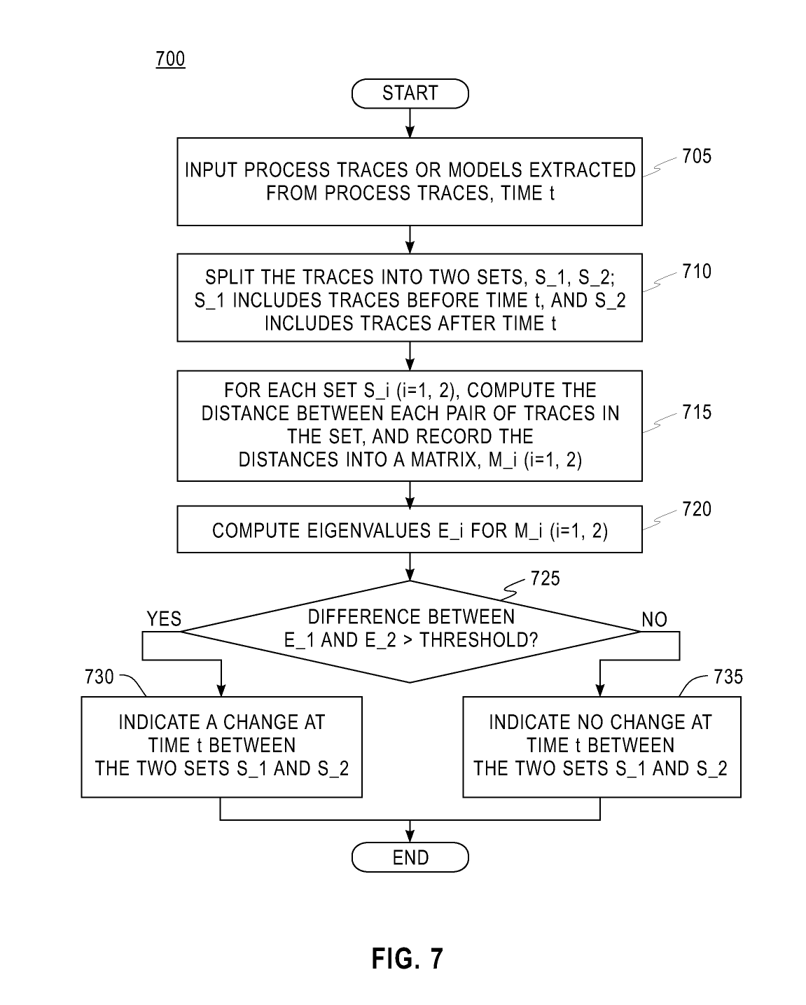

FIG. 7 is a flow diagram showing an exemplary method 700 for change detection in a business process using multi-dimensional statistical change detection, according to an embodiment of the present principles.

At step 705, a time t and process traces or models extracted from the processes traces are input. The process traces are for a business process corresponding to a set of related tasks [aᵢ] for a specified goal. Each of the models has at least a transition matrix of dimension N×N, where N is the total number of the related tasks.

At step 710, the traces or the models are split into two sets, namely a first set S_1 and a second set S_2. The first set S_1 includes any of the traces before a time t, and the second set S_2 including any of the traces after the time t.

At step 715, for each set S_i, (i=1, 2), a distance between each pair of traces therein is computed and stored in a respective one of two matrices.

At step 720, Eigenvalues E_i for M_i (i=1,2) are computed.

At step 725, it is determined whether or not a difference between E_1 and E_2 is greater than a threshold. If so, then the method proceeds to step 730. Otherwise, the method proceeds to step 735.

At step 730, a change is indicated at time t between the two sets S_1 and S_2. At step 735, no change is indicated at time t between the two sets S_1 and S_2.

Trace representation: Here is a candidate representation for traces. In order to capture the execution context of each activity in a trace, we use q-gram to parse the activity sequence into grams. As an example, suppose we observe a trace of T_1=<a, b, c, b, c>, the q-grams of length 2 from T_1 include {<a, b>, <b, c>, <c, b>}. Treat each possible q-gram as one dimension. Thus, the dimensionality of the space is the number of distinct q-grams observed in all traces. The value of a given trace (e.g., T_1) in each dimension is the count of corresponding q-grams in this trace. As another example, a trace T_2=<a, c, b, c, d> in q-gram representation is {<a, c>, <c, b>, <b, c>, <c, d>}. In matrix form, T_1 and T_2 can be represented in 5-dimensional space as follows:

$$〈 a , b 〉 〈 b , c 〉 〈 c , b 〉 〈 a , c 〉 〈 c , d 〉$$

$$\begin{matrix}T\_ 1 \\ T\_ 2\end{matrix} \begin{matrix}1 \\ 0\end{matrix} \begin{matrix}2 \\ 1\end{matrix} \begin{matrix}1 \\ 1\end{matrix} \begin{matrix}0 \\ 1\end{matrix} \begin{matrix}0 \\ 1\end{matrix} \\ ... ... .$$

Note that defining the time-series in this way is equivalent to defining the objects of interest as the transitions observed in individual traces. Thus, we might instead define the objects of interest to be the transitions found in the extracted process-model.

Problem statement: Suppose we have observed traces [T_1, T_2, T_3, . . . ], and we need to detect the change point of the underlying process model, meaning the traces [T_1, T_2, . . . , T_t] are generated from a process model different from the model that generates [T_(t+1), T_(t+2), . . . ].

Proposed solution: By representing the traces in a multi-dimensional space of q-grams, the above problem is translated into the detection of change in value distribution in the multi-dimensional space. The intuition is that traces generated from the same process model will have a spatial density distribution in the multi-dimensional space (for example, the traces form clusters). This density distribution is different from that of traces generated from another process model.

Problem abstraction: Hereafter, we assume that the traces have been represented in the matrix form (i.e., multi-dimensional time-series). The basic question we need to answer is whether the distribution of [T_(t+1), T_(t+2), . . . ] is different from the distribution of [T_1, T_2, . . . , T_t]. To make it more generic, we need to test the hypothesis that the distribution of a given set of traces S_1 is the same as the distribution of another set of traces S_2.

Overview of statistical change detection: Here is a high-level overview to test the hypothesis that the distribution of S_1 and S_2 are the same: (1) split S_1 into two partitions of approximately the same size, namely, S_11, S_12. Capture the density distribution of S_11 using kernel density estimation; denote the estimated density distribution function as F_11. Compare the likelihood of P(S_11|F_11), which measures the likelihood that S_11 comes from the distribution of F_11, and the likelihood of P(S_2|F_11). If S_2 and S_1 are actually from the same distribution, then the difference of the likelihoods d=P(S_11|F_11)−P(S_2|F_11)*|S_11|/|S_2|, where |S_11| and |S_2| are the number of traces in each set. It can be proved that the difference d follows a Gaussian distribution. Therefore, the threshold on d, to decide whether or not to reject the null hypothesis that S_1 and S_2 are from the same distribution, is determined from the Gaussian distribution to ensure that the rate of false positives (detect a change when there is no change) satisfies user-specified requirements.

The Spectral Graph Analysis Method

Here the idea is to find some numerical measure of the process-graph itself.

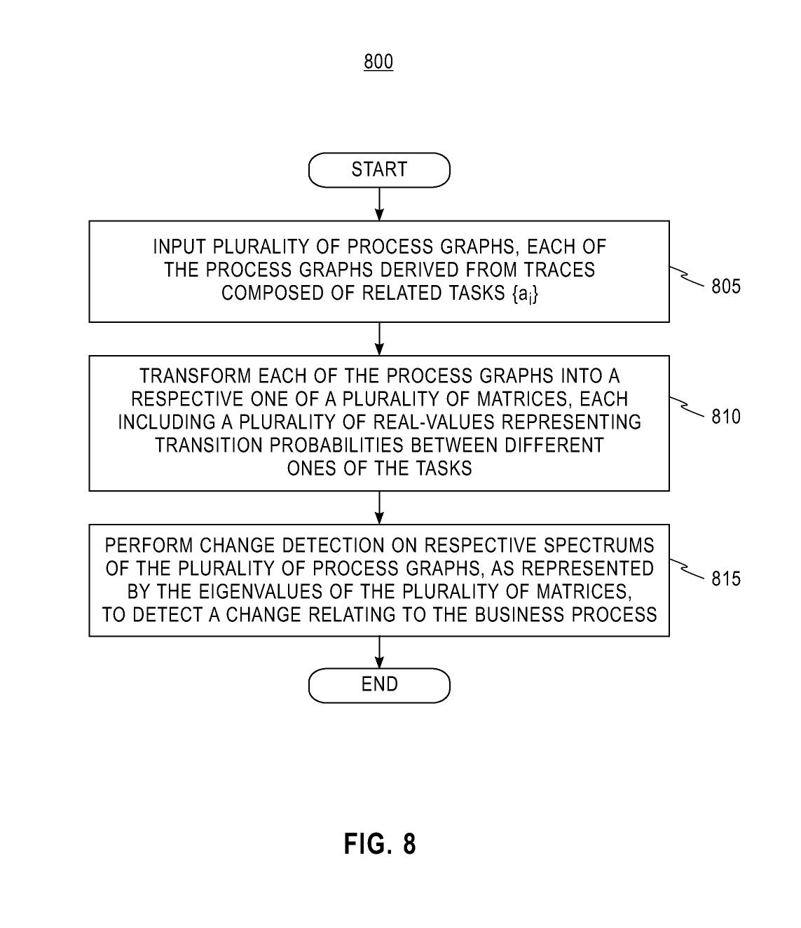

FIG. 8 is a flow diagram showing an exemplary method 800 for change detection in a business process using spectral graph analysis, according to an embodiment of the present principles.

At step 805, a plurality of process graphs is input for a business process corresponding to a set of related tasks for a specified goal.

At step 810, each of the plurality of process graphs are transformed into a respective one of a plurality of matrices. Each of the plurality of matrices includes a plurality of real-values representing transition probabilities between different ones of the related tasks.

At step 815, change detection is performed on respective spectrums of the plurality of process graphs, as represented by Eigenvalues of the plurality of matrices, to detect a change relating to the business process.

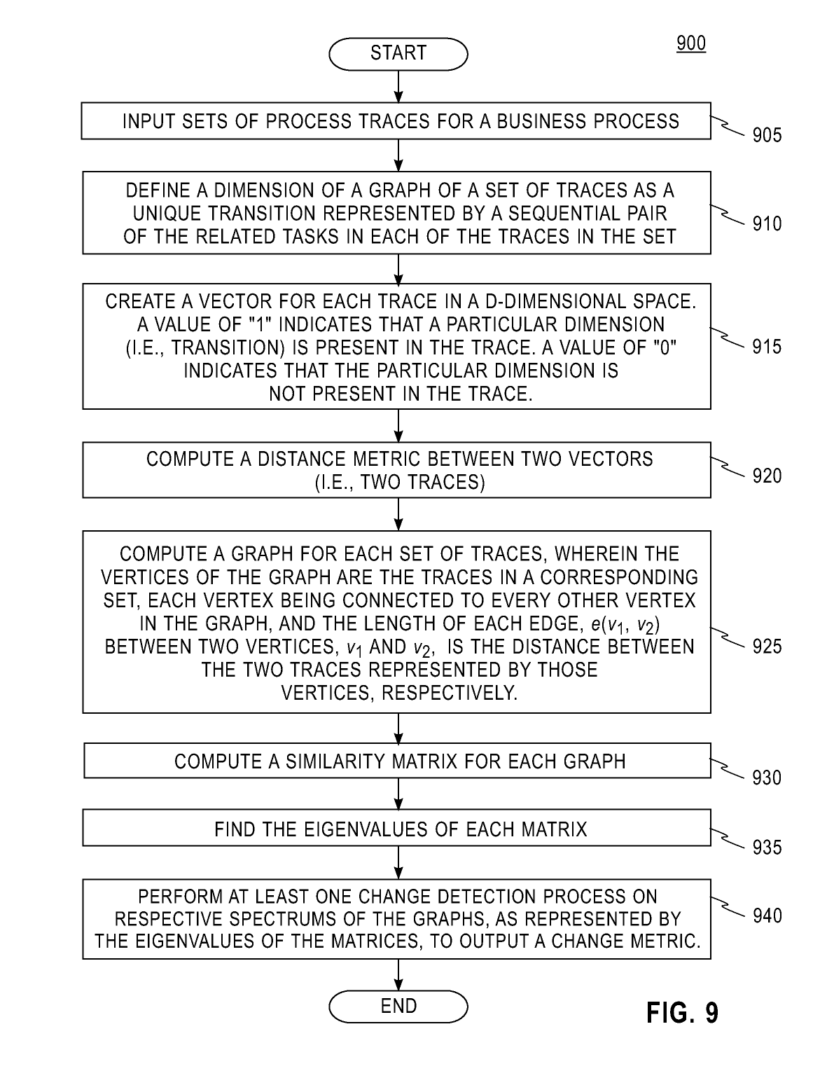

FIG. 9 is a flow diagram showing an exemplary method 900 for change detection in a business process by deriving graphs from process traces and using spectral graph analysis, according to an embodiment of the present principles. In method 800, the graphs are already in existence, and are simply transformed into matrices on whose spectrums (via the Eigenvalues) the change detection is performed. In method 900, processes traces are the input to the method, and the graphs are created from the traces, and then the matrices are created from the graphs.

At step 905, sets of process traces are input. The process traces are for a business process corresponding to a set of related tasks [aᵢ] for a specified goal.

At step 910, a dimension of a graph of a set of traces is defined as a unique transition represented by a sequential pair of the related tasks in each of the traces in the set.

At step 915, a vector is created for each trace in a d-dimensional space. A value of “1” indicates that a particular dimension (i.e., transition) is present in the trace, and a value of “0” indicates that the particular dimension is not present in the trace.

At step 920 a distance metric is computed between two vectors (i.e., two traces).

At step 925, a graph is respectively computed for each set of traces, wherein the vertices of the graph are the traces in a corresponding set, each vertex is connected to every other vertex in the graph, and the length of each edge, e(v₁, v₂) between two vertices, v₁ and v₂, is the distance between the two traces represented by those vertices, respectively.

At step 930, a similarity matrix is computed for each graph.

At step 935, the Eigenvalues of each matrix are found.

At step 940, at least one change detection process is performed on respective spectrums of the graphs, as represented by the Eigenvalues of the matrices, to output a change metric. The change metric represents at least one of when a change occurs in the spectrums and a degree of the change. Such timing information can be derived, for example, by looking at the times when the corresponding activities in the traces were performed. It is to be appreciated that the change metric may be computed using any number of ways. Some illustrative ways are described in further detail herein below.

Various methods have been proposed for ordering graphs. Thus, we note that the present principles are not limited to any particular graph ordering method and, thus, any graph ordering method may be used in accordance with the teachings of the present principles, while maintaining the spirit of the present principles.

The representation of the process graph as a matrix is standard, and the matrix of a directed graph will be non-symmetric, so that the matrix of a process-graph will generally be non-symmetric (unless every transition is bidirectional). We propose to represent the graph as a real-valued matrix, with the values representing transition probabilities, rather than as a binary {0,1} matrix, which represents only adjacency.

Then we find the Eigenvalues of the matrix (by standard methods). Since the process-graph matrix is in general non-symmetric, the N Eigenvalues of an N·N process-graph will be complex numbers. The set of Eigenvalues constitutes the “spectrum” of the graph. Isomorphic graphs produce the same spectrum, so that an unchanged process will yield an unaltered spectrum.

Although not all changes to a graph will necessarily change the spectrum, for at least two reasons, this fact is not expected to invalidate the method. First, most trees are co-spectral. However, few process-graphs will be tree-like. Second, most co-spectral graphs can be generated by “Seidel-switching”. However, in a process-graph, the types of change which are represented by a Seidel-switch are rare or even impossible.

To see the last point, consider the prior state G(t=0) and the later state G(t=1) of the same process, with ‘g’ nodes in each, and require that in both prior and later states that the process-graph G can be partitioned into two sub-graphs, Ga and Gb, such that Ga and Gb do not change from t=0 to t=1, but that all existing edges between Ga and Gb are removed and all “missing” edges between Ga and Gb are supplied (that defines “Seidel switching”). This would happen in a process, if in G(t=0) there existed some “sub-process” Gb (i.e., sub-graph of G) of two or more nodes, that was started from 0<m<g of the nodes in Ga, and ended in 0<n<g of the nodes in Ga. Then in G(t=1) the “sub-process” Gb would be started from all the g-m nodes in Ga (noting that the “end” node is included), and would end in all the g-n nodes in Ga (noting that the “start” node is included). Furthermore, notice that the sub-process would now be started at its own end-node and would end at its own start-node.

In order to compare two process-graphs G1 and G2, we would have to ensure that each has the same total dimension (N×N), i.e., total number of tasks, so that if some tasks were missing from G1 or G2, some additional pre-processing of the graph matrix would be needed. This could be done by including additional rows and columns in the smaller graph, or removing rows and columns from the larger graph, or in some other simple way.

The actual computation of the change metric from the “spectrum” could be accomplished in a variety of ways. In all of them, let the spectrum of the process at some selected “initial” time be labeled Sp(G(0)), and the spectrum of the process at the later time be labeled Sp(G(t)). Recall that |Sp(G)| will be N.

We might compute the change metric as, for example, but not limited to:

the ordinary vector “dot product” between the two spectra, Sp(G(0)) and Sp(G(t));

the ordinary determinant of the N×N matrix formed by the ordinary outer product of the two spectra, Sp(G(0)) and Sp(G(t));

a parameterized pseudo-Euclidean distance, d=Σᵢ(aᵢ·Sp(G)ᵢ), where the N {aᵢ} values are the (free) parameters that we would choose, possibly by a machine-learning algorithm or in some other way; and

the “Estrada index” defined as Σᵢ(exp(λᵢ)) for the Eigenvalues {λᵢ}.

At least two prior methods have been proposed which are directed to determining graph isomorphism, and are not applied to process-change. The first uses group theory to determine isomorphism, subject to a certain limitation on the multiplicity of the Eigenvalues (i.e., the algorithm is most efficient when each Eigenvalue is distinct). The second uses the distance matrix D, defined as an N×N matrix in which the element dᵢⱼ represents the length of the shortest path between the vertices vᵢ and vⱼ. For every such pair, there is a unique minimum distance. If i=j, then dᵢⱼ=0. If no path exists between the two vertices, then the length is defined to be infinite. Then the graph is recursively partitioned and the distance matrices of the partitions exploited to compute isomorphism mappings. Hence, neither of these methods relate to the present principles.

We now further describe the spectral graph analysis method.

We assume that there is a given set T of traces {t₁, . . . , tₖ} of a currently executing process, and the total number of traces received so far is k. We assume that from each trace we can extract the execution sequence of all activities executed in a given business process instance. For instance a sequence such as {ABDC} indicates that the execution of activity A is followed by the execution of activity B which is followed by D, and then C. The steps of our algorithm are as follows.

We define a dimension of a graph of a set of traces to be each unique transition represented by a sequential pair of activities in each trace in the set T. For instance a trace t₁ may log an activity execution sequence such as {ABCD}. In this example one can obtain 3 dimensions in the trace, namely, AB, BC, and CD. If there are A distinct activities in a set of traces T, then the space of dimensions, d, is A². Consider a set of two traces, t₁ and t₂ collected thus far where the activity sequence in each is {ABCD} and {ACBDE}. With five distinct activities, we obtain a 25 dimensional space of all possible transitions. Note that since it is quite possible that activities repeat in real business process executions, we include dimensions corresponding to the transitions: AA, BB, CC, DD, and EE.

We create a vector for each trace in a d dimensional space. In particular, for each trace we populate a d-dimensional vector, with 1 indicating that a particular dimension (i.e. transition) is present in the trace, and 0 indicating that it is not. Alternatively, one can use the number of times a particular dimension is found in the trace as a (count) value for that dimension.

We define a distance metric to represent the distance between vectors (i.e. two traces). We choose to compute the cosine similarity between a pair of d-dimensional vectors. A variety of different distance metrics may be used such as Hamming distance, Jaccard Index, Levenshtein distance, and the Generic edit distance.

We compute a graph for a given set of traces. Now we gather m successive disjoint sets {s₁, s₂, . . . , sₘ} of traces where each set contains k traces, and k>0. With the traces in a given set, s₁, we compute the complete graph, g₁, whose vertices are the k traces, and in which each vertex is connected to every other vertex in the graph. The length of each edge, e(v₁, v₂) between two vertices, v₁ and v₂ is the distance between the two traces represented by those vertices respectively. We repeat this step for each set of traces, sᵢ, and now we have m graphs {g₁, g₂, . . . , gₘ}, which we refer to as TraceGraphs. The similarity matrix of each TraceGraph is a k by k symmetric matrix (because the distance between trace t₁ and trace t₂ is the same as that between t₂ and t₁).

We compute the spectrum of each TraceGraph. For example, using standard Eigenvalue decomposition techniques, we compute the Eigenvalues of each TraceGraph. They must be real valued since the matrix of the graph is symmetric. For each TraceGraph, gᵢ, the set of its e Eigenvalues constitutes its spectrum, S(gᵢ).

We compute a metric between S(gᵢ) and S(gᵢ₊ₕ), where h>0. There are a variety of ways to compute the difference between two given graph spectra. Among others, any of the following known techniques can be applied:
dot product;
difference of the Estrada Index, Eₖ defined as Σ(exp(λᵢ)) for the Eigenvalues λᵢ of gₖ, i.e., compute Eₖ-E₀.
L1-norm. Sum of absolute values of the pairwise differences of the Eigenvalues.
L2-norm. Ordinary Euclidean distances between the two lists of Eigenvalues, treating the lists as if they were coordinates in N-dimensional space.

It should be noted that the overall algorithm provides significant flexibility in terms of (1) definition of a dimension, (2) definition of a distance metric that serves as edge lengths connecting each node in the graph, (3) the size of each set of traces, sᵢ, as well as (4) choice of metric for computing differences in graph spectra. It should be emphasized that while the number of traces needed to build each TraceGraph (referred to as k) is not required to be exactly the same, they need to be at the same scale.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A system, comprising:
a transformer for receiving a plurality of process graphs for a business process corresponding to a set of related tasks for a specified goal and transforming each of the plurality of process graphs into a respective one of a plurality of matrices, each of the plurality of matrices comprising a plurality of real-values representing transition probabilities between different ones of the related tasks; and
a change detector for performing at least one change detection process on respective spectrums of the plurality of process graphs, as represented by Eigenvalues of the plurality of matrices, to detect at least one of when a change occurs in the business process and a degree of the change.

2. The system of claim 1, wherein a change metric is computed to represent the degree of the change in the business process based on a vector dot product between the respective spectrums.

3. The system of claim 1, wherein a change metric is computed to represent the degree of the change in the business process based on a determinant of an N×N matrix formed by a outer product of the respective spectrums.

4. A method, comprising:
receiving a plurality of process graphs for a business process corresponding to a set of related tasks for a specified goal;
transforming each of the plurality of process graphs into a respective one of a plurality of matrices, each of the plurality of matrices comprising a plurality of real-values representing transition probabilities between different ones of the related tasks;
storing the plurality of matrices in a memory; and
performing at least one change detection process on respective spectrums of the plurality of process graphs, as represented by Eigenvalues of the plurality of matrices, to detect at least one of when a change occurs in the business process and a degree of the change.

5. The method of claim 4, wherein a change metric is computed to represent the degree of the change in the business process based on a vector dot product between the respective spectrums.

6. A computer program product comprising a computer readable storage medium including a computer readable program, wherein the computer readable program when executed on a computer causes the computer to perform the method steps as recited in claim 4.
